(19) United States
(12) Patent Application Publication
(10) Pub. No.: US 2021/0271731 A1
(43) Pub. Date: Sep. 2, 2021

(54) A METHOD OF PERFORMING QUANTUM FOURIER-KRAVCHUK TRANSFORM (QKT) AND A DEVICE CONFIGURED TO IMPLEMENT SAID METHOD

(71) Applicants: UNIWERSYTET WARSZAWSKI, Warszawa (PL); OXFORD UNIVERSITY INNOVATION, Oxford, Oxfordshire (GB)

(72) Inventors: Magdalena Stobinska, Warszawa (PL); Adam Buraczewski, Warszawa (PL); Ian Walmsley, Oxford Oxfordshire (GB)

(21) Appl. No.: 17/258,187

(22) PCT Filed: Jul. 4, 2019
(86) PCT No.: PCT/IB2019/055719

§ 371 Date: Jan. 6, 2021

(30) Foreign Application Priority Data
Jul. 6, 2018 (PL) P.426228

(51) Int. Cl. G06F 17/14; G06N 10/00

(52) U.S. Cl. CPC G06F 17/14; G06N 10/00

(57) ABSTRACT

The present invention relates to a method of performing a fractional quantum Fourier-Kravchuk transform (QKT), characterised in that input data sequence is encoded in quantum amplitudes of a d-level (qudit) state which is processed by a quantum gate implementing an exchange interaction, and the result is read out by means of quantum detectors located behind this device,The invention relates also to a device, in particular a quantum computer, configured to implement said method.

The invention relates to a method of performing constant-time quantum Fourier-Kravchuk transform (QKT) realized with a single quantum gate, where the input and output data is encoded in quantum amplitudes of a d-level quantum state (qudit).

Signal extraction, compression and analysis in diagnostics, astronomy, chemistry and digital broadcasting often builds on effective implementation of the discrete Fourier transform (DFT). It converts data, a function of e.g. frequency, into their constituent temporal or spatial parts. The DFT is an efficient approximation to the Fourier transform (FT). The signal (x₀, x₁, . . . , x_{S}) is taken to be samples of one period of a continuous function, and is turned into a new sequence (X₀,X₁, . . . , X_{S}) where

$${X}_{k} = \frac{1}{\sqrt{S + 1}} {\sum }_{l = 0}^{S} {e}^{- i 2 π \frac{kl}{S + 1}} \cdot {x}_{l} , k = 0 , … , S . \qquad ( 1 )$$

The DFT does not, however, reproduce all essential features of the FT. A transform which is a fractional power of the FT, the a-fractional FT where 0≤α≤1, yields advantages. For α=a 0 this transform is the identity, while for α=1 this is the FT. The α-fractional DFT defined as the α power of (1) does not correspond to the α-fractional FT.

The DFT is powerful due to the fast Fourier transform algorithm (FFT). Using an FFT lowers the number of operations from O(2²ⁿ) to O(n2ⁿ) which nevertheless remains a bottleneck in signal processing. The FFT employs a “divide and conquer” method to recursively split Eq. (1) into 2ⁿ sums which can be processed quickly and therefore, is applicable to signals of period 2ⁿ. Notably, the minimal number of operations required to implement the DFT is unknown. The quantum Fourier transform (QFT), the cornerstone of quantum algorithms, enables to implement the DFT on quantum amplitudes with O(n log n) operations by processing n qubits (n quantum bits encode 2ⁿ amplitudes).

In many applications, e.g. in bioimaging, the signals are typically not periodic and are random in length. For such cases, the Kravchuk transform (KT) is a useful alternative to the FFT because it can be applied to finite signal processing.

The KT computes orthogonal moments corresponding to the Kravchuk polynomials, which are discrete and orthogonal with respect to a binomial distribution in the data space. By varying a parameter of the binomial distribution, related to the fractionality of the KT, the transform can extract local features from a region of interest.

The KT's computational time is equal to the DFT's runtime and implementations with lower number of operations are of high demand. Recently, quantum KTs (QKTs) have been realized in waveguides with two photons, but they are difficult to scale up and their fractionality is fixed by waveguide length.

The α-fractional KT employs the weighted Kravchuk polynomials ϕₖ^{(p)}(q,S) which are real-valued and correspond to wave functions of finite harmonic oscillators

$${X}_{k} = {\sum }_{l = 0}^{S} {e}^{- i \frac{πα}{2} \frac{S}{2}} {e}^{i \frac{π}{2} ( l - k )} {ϕ}_{k}^{( p )} ( l - Sp , S ) \cdot {x}_{l} , k = 0 , … , S , \qquad ( 2 )$$

$${e}^{- i 2 π \frac{kl}{S + 1}} ,$$

where

$$p = {sin}^{2} ( \frac{πα}{4} ) .$$

Unlike plane waves, the polynomials are defined and orthogonal on a set of S+1 points. This enables one to transform the signal as a finite sequence rather than as an infinite periodic one. In the limit of S→∝, ϕₖ^{(p)}(q,S) tend to eigenfunctions of quantum harmonic oscillators and the a-fractional KT reproduces the a-fractional FT. Eq. (2) can be viewed in terms of overlaps of two spin S/2 states, in which they are prepared as eigenstates of S₃ and one undergoes a rotation by angle

$$\frac{πα}{2}$$

generated by S₁,

$${e}^{i \frac{π}{2} ( l - k )} {ϕ}_{k}^{( p )} ( l - Sp , S ) = 〈 \frac{S}{2} , \frac{S}{2} - k \vert {e}^{i \frac{πα}{2} {S}_{1}} \vert \frac{S}{2} , \frac{S}{2} - l 〉 . \qquad ( 3 )$$

The present invention builds on the discovery that physical systems realizing the Hong-Ou-Mandel (HOM) quantum interference can be used to calculate the quantum fractional Fourier-Kravchuk transform with a single quantum gate. Moreover, each quantum system described by the same Hamiltonian can be used as a device computing this transform. In addition, the strength of the implemented exchange interaction corresponds to the fractionality of the Kravchuk transform, e.g. for a quantum gate made of a beam splitter (BS)

$$α = \frac{2 θ}{π} ,$$

Γ=arcsin \sqrt{r}, where r is the splitting ratio (reflectivity).

The object of the present invention is a method of performing a fractional quantum Fourier-Kravchuk transform (QKT), characterised in that input data sequence is encoded in quantum amplitudes of a d-level (qudit) state which is processed by a quantum gate implementing an exchange interaction, and the result is read out by means of quantum detectors located behind this device, wherein:
the interaction of two independent modes a and b in the quantum gate is governed by the following Hamiltonian

H=H₀+H_{I},
wherein H₀ is the free quantum oscillator energy and H_{I}—the interaction Hamiltonian

$${H}_{0} = \frac{ℏ}{2} ( {a}^{†} a + {b}^{†} b ) , \\ {H}_{I} = \frac{i ℏ}{2} ( {ga}^{†} b - {g}^{*} {ab}^{†} ) ,$$

where g corresponds to the exchange interaction strength and g* is its complex conjugate,
the evolution operator generated by the Hamiltonian H is the following

U=exp{−iθH/h},
where θ is an evolution parameter, e.g. time,
the quantum input state |Ψ [symbol] =Σₗ₌₀^{S}xₗ|l, S−l [symbol] encodes the sequence to be transformed (x₀,x₁, . . . , x_{S}),
the exchange interaction followed by particle-counting detection implements the α-fractional QKT transform of the input probability amplitudes

(x₀, x₁, . . . , x_{S})→(|X₀|², |X₀|², . . . , |X_{S}|²)

where

$$α = \frac{2 \vert g \vert θ}{π}$$

and |Xₖ|² are experimentally determined particle number statistics for k=0, . . . , S which correspond to

$${X}_{k} = {\sum }_{l = 0}^{S} {e}^{- i \frac{πα}{2} \frac{S}{2}} {e}^{i \frac{π}{2} ( l - k )} {ϕ}_{k}^{( p )} ( l - Sp , S ) \cdot {x}_{l} , k = 0 , … , S$$

$$where p = {sin}^{2} \frac{πα}{4} .$$

Preferably the strength of an exchange interaction g can be adjusted, for example by a variable exchange interaction device (quantum gate).

In one of implementations the input data are encoded as superposition of multiphoton Fock states that interfere on a e beam splitter with the beam splitting ratio r, and the result is read from the system by means of photon detectors counting, wherein g=−i(|g|=1) and the α-fractional QKT transform is performed, where the fractionality is expressed by the formula

$$α = \frac{2}{π} arcsin \sqrt{r} .$$

Preferably the beam splitter is a variable ratio beam splitter.

Counting detectors can be superconducting Transition Edge Sensors (TESs).

The invention relates also to a device, in particular a quantum computer, configured to implement the method according to the invention.

Realization of the fractional QKT with qudit systems opens a new prospect for transformation of large data sequences in O(1) time. This is not possible with the implementations based on waveguides. Both cases are examples of a non-universal quantum computer optimized for one task which is the basis for a variety of important applications. The photonic proof of concept is currently limited by the range of input states that can be prepared. However, deterministic creation of an arbitrary superposition of Fock states has been demonstrated for trapped ions and superconducting resonators. Since a BS sees orthogonal spectral or polarization modes independently, one can extend the transform to higher dimensions.

The invention is not limited to optical devices. There are numerous quantum systems built with e.g. ions, neutral atoms in optical lattices, semiconductor or superconducting chips, plasmons on the surface of metamaterials, which perform exactly the same mathematical operation as a beam splitter or an operation which could be mapped into it. Thanks to this method, it is possible to use the speed offered by quantum technologies for many applications in computer science, robotics, medicine, in which the quick calculation of this transform for large data sets is crucial.

The QKT could also be implemented with the existing quantum annealing processors, which operate on a chain of interacting spin-½ systems, and using HOM interference of fermions with symmetric wavefunction of the interfering degrees of freedom symmetric.

### BRIEF DESCRIPTION OF FIGURES

FIG. 1—Photonic implementation of a fractional QKT-HOM interference of photon number states on a variable beam splitter followed by two photon counting detectors,

FIG. 2—Setup: Ti:Sa—titanium-sapphire laser pump, BS 50:50 beam splitter, τ-optical phase delay, SPDC periodically-poled potassium titanyl phosphate (PP-KTP) nonlinear spontaneous parametric down conversion waveguide chip which produces photon number correlated states, PBS polarization beam splitter, VC variable coupler, TES transition edge sensors, DAQ data acquisition unit.

FIG. 3—Photon number statistics resulting from Fock state |l, S−1 [symbol] interference. The probabilities of detecting |k [symbol] and |S−k [symbol] photons behind the BS for input a) |0,3 [symbol] , b) |0,4 [symbol] , c) |0,5 [symbol] , d) |1,2 [symbol] , e) |2,2 [symbol] , f) |2,3 [symbol] . The BS reflectivities are r=0.05, 0.2, 0.5 and 0.95. Vertical bars represent theoretical values for an ideal system, while dots are values determined in experiment. The states a)-c) encode sequences (x₀=1,x₁=0, . . . , x_{S}=0), and in d)—(0,1,0,0), c)—(0,0,1,0,0), f)—(0,0,1,0,0,0), respectively. The measured probabilities set their QKTs (|X₀|², |X₁|², . . . ,|X_{S}|²) of fractionality α=0.28, 0.60 , 1.00 and 1.72.

### EXAMPLE

As an example, a single-step QKT with tunable fractionality using quantum effects, based on multi-particle bosonic interference resulting from an exchange interaction was demonstrated. To this end, photon number states (light pulses with definite particle number) were interfered on a BS with an adjustable splitting ratio. This leads to a multi-particle HOM effect which was observed for states with up to five photons. This QKT implementation enables constant-time information processing for qudit data encoding which is set by the total number of interfering particles S, allowing up to d=S+1 signal samples.

Photon number (Fock) states

$$\vert l 〉 = \frac{{( {a}^{†} )}^{l}}{\sqrt{!}} \vert 0 〉 and \vert S - l 〉 = \frac{{( {b}^{†} )}^{S - l}}{\sqrt{( S - l ) !}} \vert 0 〉$$

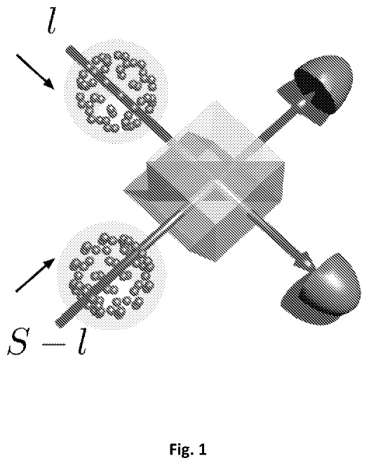

impinging on a BS exhibit a generalized HOM effect (FIG. 1). A BS interaction between two such inputs described by annihilation operators a and b is

$${U}_{BI} = exp \{ \frac{θ}{2} ( {a}^{†} {be}^{- i φ} + {ab}^{†} {e}^{i φ} ) \}$$

where

$$r = {sin}^{2} \frac{θ}{2}$$

is the BS reflectivity and φ is the phase difference between the reflected and transmitted fields. Since φ does not influence this experiments,

$$φ = \frac{π}{2}$$

may be assumed for convenience. If the BS is balanced (r=0.5), two photons at the input ports will leave through the same exit port. This is known as photon bunching. Similar effects hold for multiphoton number states. This is reflected in the probability amplitudes of detecting |k [symbol] and |S−k [symbol] behind the BS,

$${A}_{S}^{( k )} ( k , l ) = {e}^{- i θ \frac{S}{2}} 〈 k , S - k \vert {U}_{BS} \vert l , S - l 〉 .$$

This is important for implementing the KT, since

$${A}_{S}^{( r )} ( k , l ) = {e}^{- i θ \frac{S}{2}} {e}^{i \frac{π}{2} ( l - k )} {ϕ}_{k}^{( r )} ( l - Sr , S ) ;$$

thus, if we send a quantum state |Ψ [symbol] =Σₗ₌₀^{S}xₗ|l, S−1 [symbol] into the BS, the probability of measuring k and S−k photons behind is the absolute square of a

$$\frac{2 θ}{π}$$

fractional QKT of the input probability amplitudes, |Xₖ|²=|Σₗ₌₀^{S}A_{S}^{(r)}(k,l)xₗ|². Since two-mode optical interference can be achieved in a single step, regardless of the number of photons involved, this process implements a constant time QKT.

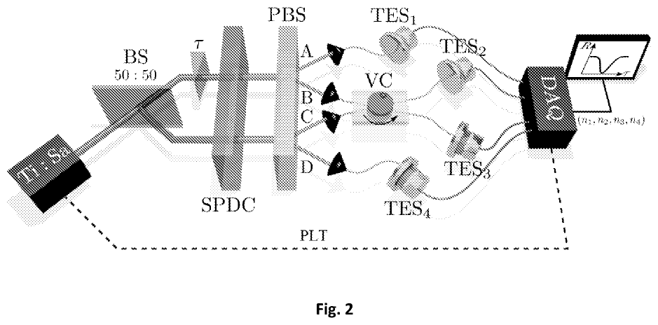

The experimental setup for multiphoton HOM interference is depicted in FIG. 2. Two pulsed spontaneous parametric down-conversion (SPDC) sources each generate two-mode photon-number correlated states (see Methods). The signal and idler are separated with a polarization BS (PBS) into four spatial modes. The modes A and D are used for heralding and creation of Fock states |l [symbol] in B and |S−l [symbol] in C which interfere in a variable ratio fiber coupler (the BS). An optical path delay τ in one of the pump beams ensures optimal temporal overlap at interference. Photon-number-resolved measurements are achieved using transition edge sensors (TESs) that was previously estimated to achieve over 90% efficiency.

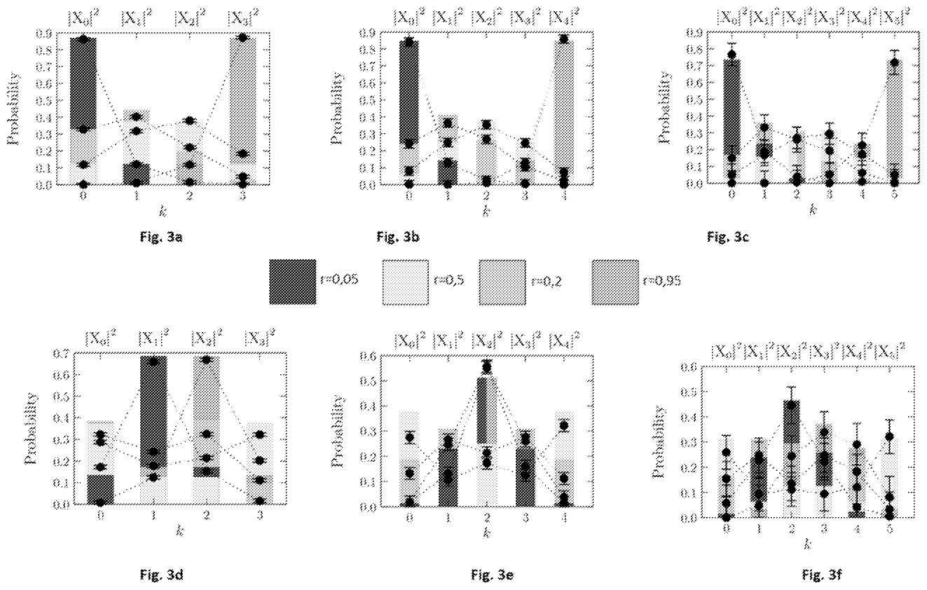

The vacuum |0 [symbol] (l=0) with multiphoton Fock states |S [symbol] (S−l=S) were interfered on a coupler with splitting ratios r=0.05, r=0.2, r=0.5 and r=0.95, and photon number statistics were measured. They are depicted in FIGS. 3a-c for S=3, 4, 5. The input states encode sequences (x₀=1,x₁=0, . . . , x_{S}=0), while the measured probabilities set their QKTs: (|X₀|², |X₁|², . . . , |X_{S}|²), where |Xₖ|²=|A_{S}^{(r)}(k, 0)|². The reflectivities used correspond to fractionalities α=0.28, 0.60, 1.00, 1.72. Errors were estimated as a square root inverse of the number of measurements. The second-order interferometric visibility reached values between 71.4% and 98.6% for S=5.

For the same values of r photon number distribution resulting from interference of |1,2 [symbol] , |2,2 [symbol] and |2,3 [symbol] was measured. They are shown in FIGS. 3d-f. The inputs encode (0, 1, 0, 0, 0, 0, 1, 0, 0), (0, 0, 1, 0, 0, 0), while |Xₖ|²=|A₃^{(r)}(k, 1)|², |A₄^{(r)}(k,2)|² and |A₅^{(r)}(k, 2)|², respectively. The visibility was between 54.8% and 99.5% (S=5).

FIG. 3 shows that the theoretical values computed for an ideal system (the bars) match the experimental results (the dots) well.

Methods

A light pulse from a Ti:Sapphire laser at 775 nm (FWHM of 2 nm; repetition rate of 75 kHz) pumps collinear type-II phase-matched 8 mm-long SPDC waveguides written in a periodically poled KTP (PP-KTP) crystal sample provided by AdvR Inc. They generate two independent photon-number correlated states—the two-mode squeezed vacua |Ψ [symbol] =Σₙ₌₀^{∞}λₙ|n, n [symbol] , where

$${λ}_{n} = \frac{{tanh}^{n} g}{cosh g}$$

is a probability amplitude for creation of a pair of n photons and g is the parametric gain. The average photon number in the signal and idler mode equals [symbol] \hat{n} [symbol] =sin h² g. For small g, cosh g♯1 , and thus λₙ²≈sin h²ⁿ g= [symbol] \hat{n} [symbol] ⁿ. In the experiment, the average photon number is [symbol] \hat{n} [symbol] ≈0.2. This value is sufficient to ensure the emission of multiphoton pairs, but at the same time to diminish the interferometric visibility of two-photon events. In both output states, the signal and idler pulses are split with a polarization beam-splitter (PBS) to four spatial modes AD. Subsequently, they are filtered by Semrock bandpass filters with 3 nm FWHM angle-tuned to the central wavelength of their respective spectra, in order to reduce the broadband background typically generated in dielectric nonlinear waveguides. The pump beam is discarded with a Semrock edge filter. The modes A and D are used for heralding and conditional creation of Fock states in modes B and C which interfere in a variable ratio PM fiber coupler F-CPL-1550-P-FA by Newport. The heralding signal modes (H-pol.) are centered at 1554 nm, while the interfering idler modes (Vpol.) are at 1546 nm. Transition-edge sensors (TES) running at 70 mK which allow for photon-number resolved measurements in all modes was employed. Their voltage output is captured with an AlazarTech ATS9440 ADC card was employed.

Before demonstrating the HOM interference, the setup was characterized. A high photon number resolution and single-mode input states are pivotal for this experiment. The resolution was estimated to be 95%. The depth of the HOM dip of 85.9%±0.3% for a two-photon interference indicates an effective Schmidt mode number K=1.16. For the measured 4-tuples of photon numbers losses were computed by assuming perfect setup components, each followed by a beam splitter with a reflection coefficient introducing the loss. The total transmission in each mode was estimated to be 50%.

Measurements for individual settings of the splitting ratio were taken over ca. 400 seconds, giving 10⁹ data samples for each r ranging from 0 to 1 with a step of ca. 3%. Small error bars for low photon numbers and larger bars for the higher ones result from keeping the pump power fixed and near-single-modeness of the interfering beams.

1. A method of performing a fractional quantum Fourier-Kravchuk transform (QKT), characterised in that input data sequence is encoded in quantum amplitudes of a d-level (qudit) state which is processed by a quantum gate implementing an exchange interaction, and the result is read out by means of quantum detectors located behind this device, wherein:
the interaction of two independent modes a and b in the quantum gate is governed by the following Hamiltonian
H=H₀+Hᵤ
wherein Ho is the free quantum oscillator ene Hi—the interaction Hamiltonian
$${H}_{0} = \frac{ℏ}{2} ( {a}^{†} a + {b}^{†} b ) , \\ {H}_{I} = \frac{i ℏ}{2} ( {ga}^{†} b - {g}^{*} {ab}^{†} ) ,$$
where g corresponds to the exchange interaction strength and g* is its complex conjugate,
the evolution operator generated by the Hamiltonian H is the following
U=exp{−WH/h},
where Q is an evolution parameter, e.g. time,
the quantum input state \Y)=Σₗ₌₀^{S} xₗ, S−1) encodes the sequence to be transformed (xo,xi, . . . , xs),
the exchange interaction followed by particle-counting detection implements the a-fractional QKT transform of the input probability amplitudes (x₀,w₁, . . . , x_{S})→(|X₀|², |X|², . . . , |X_{S}|²)
where a=\Xₖ\² are experimentally determined particle number statistics
$$\frac{2 \vert g \vert θ}{π}$$
and for k=0, . . . , S which correspond to
$${X}_{k} = {\sum }_{l = 0}^{S} {e}^{- i \frac{πα}{2} \frac{S}{2}} {e}^{i \frac{π}{2} ( l - k )} {ϕ}_{k}^{( p )} ( l - Sp , S ) \cdot {x}_{l} , k = 0 , … , S$$
$$where p = {sin}^{2} \frac{πα}{4} .$$

2. The method according to claim 1, wherein the strength of an exchange interactit g can be adjusted.

3. The method according to claim 2, wherein the strength of an exchange interaction g can be adjusted by a variable exchange interaction device (quantum gate).

4. The method according to claim 1, where the input data are encoded as superposition of multiphoton Fock states that interfere on a beam splitter with the beam splitting ratio r, and the result is read from the system by means of photon counting detectors, wherein g=−i (\g\=1) and the a--fractional QKT transform is performed, where the fractionality is expressed by the formula a=
−p arcsin Vr.

5. The method according to claim 4, wherein the beam splitter is a variable ratio beam splitter.

6. The method according to claim 4, wherein counting detectors are superconducting Transition Edge Sensors (TESs).

7. A device, in particular a quantum computer, configured to implement the method according to claim 1.
